(19) United States
(12) Patent Application Publication
(10) Pub. No.: US 2010/0060991 A1
(43) Pub. Date: Mar. 11, 2010

(54) Electrically-Controlled, Variable Focal Length Liquid-Based Optical Imaging Apparatus and Method

(75) Inventors: Songlin Zhuang, Shanghai (CN); Jiabi Chen, Shanghai (CN); Runling Peng, Shanghai (CN)

Correspondence Address: Curtis A. Vock;LATHROP & GAGE LLP, 4845 Pearl East Circle, Suite 201, Boulder, CO, 80301, US

(73) Assignee: OmniVision Technologies, Inc., Santa Clara, CA (US)

(21) Appl. No.: 12/208,908

(22) Filed: Sep. 11, 2008

(51) Int. Cl. G02B 3/14

(52) U.S. Cl. 359/666

(57) ABSTRACT

An optical imaging apparatus having a variable focal length is disclosed. The optical imaging apparatus includes a first double-liquid variable focal lens and a second double-liquid variable focal lens. The first and second double-liquid variable focal lenses are aligned on a common axis and operable to have opposite varying curvatures.

### FIELD OF THE INVENTION

This invention relates generally to liquid lenses. More particularly, this invention relates to an electrically-controlled, variable focal length optical imaging apparatus and method based on double-liquid lenses.

### BACKGROUND OF THE INVENTION

Optical lenses are optical devices that refract light to form an image of an object. They are fundamental components of any imaging system, including viewing devices such as glasses, binoculars and telescopes, scientific instruments such as microscopes and spectroscopes, analog and digital cameras, video cameras, medical devices such as optical catheter and endoscopes, and the like. There are many types of optical lenses available today, manufactured from various materials and having different characteristics. Selecting a lens for use in an imaging device depends mostly on how the lens' characteristics enable the device to perform its specialized functions.

One of the most decisive characteristics is the lens' focal length. The focal length of an optical lens is a measure of how strongly it converges (i.e., focuses) or diverges (i.e., diffuses) light. Light rays from a distant object enter a lens and converge into a region called the focal point. The distance between the center of the lens and the focal point is the focal length. In cameras, for example, the lenses are separated from the film or image sensor by their focal length.

The focal length of a lens is determined by the curvature, thickness and type of materials used in the lens. Short focal lengths yield wider angles of view and higher magnification. A lens with a shorter focal length also has greater optical power than one with a long focal length. In a camera, this translates into the amount of scene that is captured in the film or sensor. Lenses with shorter focal length are able to capture more of an image scene than lenses with longer focal length. Smaller objects require shorter focal lengths and vice-versa.

The focal length of a lens may therefore need to be adjusted in many imaging devices in order to properly capture an image of an object. Lenses having fixed focal lengths may typically require a mechanical or other optical compensation assembly to move the lenses so images are captured with the appropriate magnification. In a camera, for example, the focal length of a zoom lens may be adjusted by moving a set of fixed lenses closer or farther away from the film or image sensor. As the set is moved, an image of an object can be lined up so it falls directly on the film or image sensor.

Both the mechanical and optical compensation techniques require precise control of the mechanical position of the lens. Additionally, precisely spaced cams or gears must be used to implement synchronized movements. Such conventional solutions have been considered to be complicated, fragile and thus expensive. The assembly together with the lens set may be heavy and slow to adjust. They are also not convenient to be implemented in small spaces, such as in miniature cameras used in mobile devices. In these cases, mechanical movement is less suited because it makes the devices susceptible to wear and is hampered by surface tension.

An alternative approach is to use lenses having variable focal lengths. Such lenses may have a variable surface or material. For example, a refraction-diffraction combined variable focal lens based on LCD Fresnel lenses has been previously proposed. Electrically motivated, the LCD Fresnel lenses can vary the focal length by changing the refractive index of the LCD material without involving any motorized movements. However, disadvantages such as large chromatic aberrations and difficulties in keeping the image plane fixed pose an obstacle to the practical use of these lenses.

Variable focal lenses based on the electrowetting principle have also been proposed. The electrowetting principle refers to the change in the surface interface between two materials as a result of a voltage difference. A conventional variable focal lens based on electrowetting is illustrated in FIG. 1. Variable focal lens 100 is a double-liquid lens formed with a cylindrical chamber 105 enclosing two liquids, liquid 110 and liquid 115. Liquid 110 is a conducting liquid with refractive index n₁ and liquid 115 is an insulating liquid with refractive index n₂. As a result, liquid interface 120 between the two liquids 110-115 acts as a spherical lens.

A thin electrode layer 125 and a hydrophobic dielectric layer 130 with thickness d and relative permittivity εᵣ are coated inside the cylindrical chamber 105, which is typically a glass chamber with a transparent cap 135 placed on top. A voltage U is applied with a power supply 140 between the conducting liquid 110 and the electrode layer 125. The applied voltage results in a surface charge along the two sides of hydrophobic dielectric layer 130 between electrode layer 125 and conducting liquid 110. Because the amount of liquid inside cylindrical chamber 105 remains the same, this additional force results in a change in radius of curvature of interface 120 between the two liquids 110-115. The relationship between the applied voltage U and the changing radius r of the liquid interface 120 can be described as follows:

r=−a/[cos θ₀+ε₀εᵣU²/(2γ₁₂d)] (1)

where a is the inner radius of the cylindrical chamber 105, θ₀ is the initial contact angle when there is no external voltage applied, εₐ is the permittivity of free space and γ₁₂ is the tension coefficient of liquid interface 120 between liquids 110-115.

Unlike conventional variable focal lenses, double-liquid variable focal lens 100 changes its focal length electrically rather than mechanically. The disadvantages of other conventional variable focal lenses, such as the LCD Fresnel lenses described above, are also avoided. Furthermore, because of the cylinder geometry of lens 100, interface 120 stays well centered, even when changing its curvature. By matching the density of liquids 110-115, lens 100 becomes stable against shocks and vibrations.

Additionally, the switching speed of lens 100 is very small for the typical applied voltages, e.g., under 20 ms for a 3 mm diameter lens, thereby making double-liquid variable focal lenses particularly suitable for use in small devices. However, one double-liquid variable focal lens cannot keep the image plane fixed while it changes its focal length. A fixed image plane ensures that the acquired image is properly focused and formed on the image acquisition surface, such as a film or image sensor.

Accordingly, it would be desirable to provide an optical imaging apparatus and method based on double-liquid lenses that are capable of achieving a variable focal length and an invariable image plane without any mechanical movements.

### SUMMARY OF THE INVENTION

The invention includes an optical imaging apparatus having a variable focal length. The optical imaging apparatus includes a first double-liquid variable focal lens and a second double-liquid variable focal lens. The first and second double-liquid variable focal lenses are aligned on a common axis and operable to have opposite varying curvatures.

An embodiment of the invention includes a method for providing a plurality of focal lengths without requiring mechanical movement. A first double-liquid variable focal lens and a second double-liquid variable focal lens are designed and operable to have opposite varying curvatures. The first and second double-liquid variable focal lenses are aligned on a common axis.

Another embodiment of the invention includes a method of fabrication of an optical imaging apparatus having a variable focal length. A first and a second double-liquid variable focal lenses are fabricated. The first and the second double-liquid variable focal lenses are arranged in a package. A programmable controller is provided in the package to apply a first voltage to the first double-liquid variable focal lens and a second voltage to the second double-liquid variable focal lens. The first voltage controls a first curvature on the first double-liquid variable focal lens and the second voltage controls a second curvature on the second double-liquid variable focal lens.

A further embodiment of the invention includes a programmable multi-focal camera. The programmable multi-focal camera has an image sensor to generate image data from an optical image and a programmable optical assembly to capture the optical image. The programmable optical assembly has a first and a second double-liquid variable focal lens and a programmable controller configured to independently address a first voltage to the first double-liquid variable focal lens and a second voltage to the second double-liquid variable focal lens to provide a plurality of focal lengths and an invariable image plane at the image sensor.

Another embodiment of the invention includes a variable focal lens having a cylindrical chamber. A first and a second liquid layer holding a liquid of a first type are enclosed within the cylindrical chamber. A third liquid layer holding a liquid of a second type is placed in between the first and the second conducting liquid layers.

A further embodiment of the invention includes a method of fabrication of an optical imaging apparatus having a variable focal length. A triple-layer, double-liquid variable focal lens is fabricated, having a first and a second liquid layers holding a liquid of a first type and a third liquid layer holding a liquid of a second type placed in between the first and the second liquid layers. The triple-layer, double-liquid variable focal lens is arranged in a package. A programmable controller is provided in the package to apply voltages to the liquid layers.

### BRIEF DESCRIPTION OF THE DRAWINGS

The invention is more fully appreciated in connection with the following detailed description taken in conjunction with the accompanying drawings, in which like reference characters refer to like parts throughout and in which:

FIG. 1 illustrates a prior art double-liquid variable focal lens;

FIG. 2 illustrates an optical imaging apparatus constructed in accordance with an embodiment of the invention;

FIG. 3 illustrates an optical imaging apparatus in which two double-liquid variable focal lenses are operable to have opposite varying curvatures and constructed in accordance with an embodiment of the invention;

FIG. 4 illustrates a graph showing the focal length of an optical imaging apparatus constructed in accordance with an embodiment of the invention as a function of the voltage applied to the first double-liquid variable focal lens;

FIG. 5 illustrates a flow chart for providing a plurality of focal lengths without mechanical movements in accordance with an embodiment of the invention;

FIG. 6 illustrates a flow chart for fabricating an optical imaging apparatus having a variable focal length in accordance with an embodiment of the invention;

FIG. 7 illustrates multiple configurations for the double-liquid variable focal lenses used in the optical imaging apparatuses of FIGS. 2-3 in accordance with an embodiment of the invention;

FIG. 8 illustrates an optical imaging apparatus having a single, triple-layer, double-liquid variable focal lens constructed in accordance with an embodiment of the invention;

FIG. 9 illustrates an optical imaging apparatus having a single, triple-layer, double-liquid variable focal lens constructed in accordance with an embodiment of the invention;

FIG. 10 illustrates a graph showing the focal length of an optical imaging apparatus constructed in accordance with FIG. 9 as a function of the voltage applied to the triple-layer, double-liquid variable focal lens;

FIG. 11 illustrates an optical imaging apparatus constructed in accordance with an embodiment of the invention;

FIG. 12 illustrates an optical imaging apparatus constructed in accordance with another embodiment of the invention;

FIG. 13 illustrates a schematic diagram of an optical imaging apparatus when both double-liquid variable focal lenses operate with planar liquid interfaces in accordance with an embodiment of the invention;

FIG. 14 illustrates a schematic diagram of an optical imaging apparatus when both double-liquid variable focal lenses operate with non-planar liquid interfaces in accordance with an embodiment of the invention;

FIG. 15 illustrates a graph showing the interface radius of the second double-liquid variable focal lens as a function of the interface radius of the first double-liquid variable focal lens in accordance with an embodiment of the invention;

FIG. 16 illustrates a graph showing the voltage applied to the second double-liquid variable focal lens as a function of the voltage applied to the first double-liquid variable focal lens in accordance with an embodiment of the invention;

FIG. 17 illustrates a graph showing the focal length of an optical imaging apparatus constructed in accordance with an embodiment of the invention as a function of the voltage applied to the first double-liquid variable focal lens,

FIG. 18 illustrates a programmable multi-focal camera constructed in accordance with an embodiment of the invention; and

FIG. 19 illustrates a programmable multi-focal camera constructed in accordance with another embodiment of the invention.

### DETAILED DESCRIPTION OF THE INVENTION

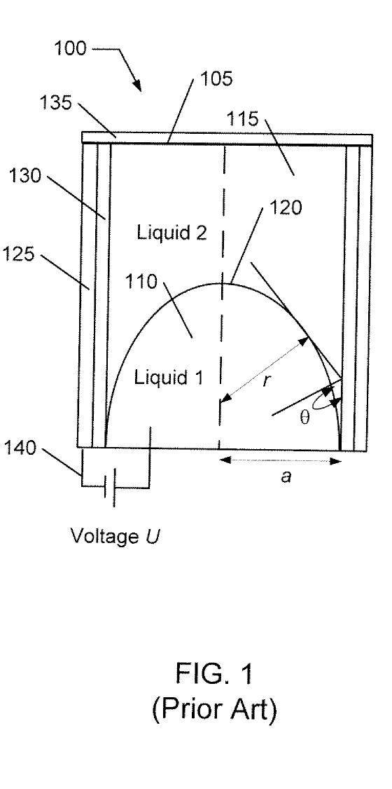

An optical imaging apparatus having a variable focal length is provided. The optical imaging apparatus is based on a double-liquid variable focal lens. As generally used herein, a double-liquid variable focal lens may be any lens formed of two liquids inside a chamber, such as, for example, the double-liquid variable focal lens shown in FIG. 1. According to an embodiment of the invention, one liquid is a conducting liquid with refractive index n₁ and another liquid is an insulating liquid with refractive index n₂. The conducting and insulating liquids have substantially the same density, thereby resulting in a liquid interface between them that acts as a spherical lens.

In one embodiment, two double-liquid variable focal lenses are aligned on a common axis and operable to have opposite varying curvatures. The two lenses may be placed in a number of configurations described below depending on the position of the conducting and insulating liquids of the two lenses relative to each other. It is appreciated that opposite varying curvatures, as generally used herein, refer to curvatures that vary in opposite directions from each other to have opposite signs, for example, one curvature varying in a convex (positive) direction and another curvature varying in a concave (negative) direction. Opposite curvatures may have the same or a different radius.

In another embodiment, a triple-layer, double-liquid variable focal lens having three liquid layers is provided. This lens may be formed of a liquid layer holding a liquid of a first type placed in between two liquid layers holding a liquid of a second type. The liquid of the first type may be a conducting liquid and the liquid of the second type may be an insulating liquid. Conversely, the liquid of the first type may be an insulating liquid and the liquid of the second type may be a conducting liquid. The three liquid layers form two liquid interfaces that are operable to have opposite varying curvatures.

In a further embodiment, an optional fixed lens is aligned with two double-liquid variable focal lenses or with a single, triple-layer double-liquid variable focal lens. A fixed lens, as generally used herein, may be any lens having a fixed position in an optical device.

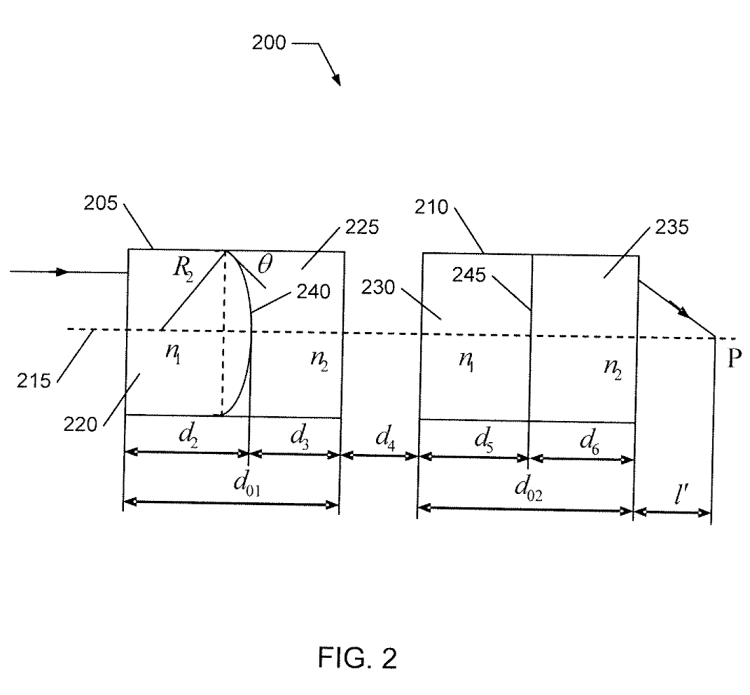

FIG. 2 illustrates an optical imaging apparatus constructed in accordance with an embodiment of the invention. Optical imaging apparatus 200 includes double-liquid variable focal lens 205 and double-liquid variable focal lens 210 aligned on common axis 215. Double-liquid variable focal lenses 205-210 may be any double-liquid variable focal lens known to one of ordinary skill in the art, such as, for example, double-liquid variable focal lens 100 shown in FIG. 1.

Double-liquid variable focal lenses 205-210 are formed of two liquids enclosed in a cylindrical chamber, such as liquids 220-225 in lens 205 and liquids 230-235 in lens 210. Each one of liquids 220-225 and liquids 230-235 is a conducting liquid having a given refractive index, while the other one of liquids 220-225 and liquids 230-235 is an insulating liquid. For example, liquids 225 and 235 may be conducting liquids while liquids 220 and 230 may be insulating liquids. As described in more detail herein below, several configurations of conducting and insulating liquids may be used in lenses 205-210.

In one embodiment, the same conducting liquid may be used in lenses 205-210. Similarly, the same insulating liquid may be used in lenses 205-210. The conducting liquid and the insulating liquids may have substantially the same density but different refractive indices, thereby resulting in a liquid interface between them that acts as a spherical lens, such as liquid interface 240 in lens 205 and liquid interface 245 in lens 210.

As described above, a voltage may be applied between an electrode layer (not shown) coated inside the cylindrical chamber of lens 205 and the conducting liquid in each one of lenses 205-210 to alter the curvature of liquid interfaces 240 and 245 and change the focal length of lenses 205-210, respectively. For example, liquid interface 240 in double-liquid variable focal lens 205 is altered in a positive direction to have a positive curvature while liquid interface 245 in double-liquid variable focal lens 210 has a planar curvature.

The effect of the applicable voltages on the curvature of the lenses can be described as follows. Let n₁ be the refractive index of the insulating liquids and n₂ be the refractive index of the conducting liquids, with n₁>n₂. Various optical distances between double-liquid variable focal lenses 205-210 are as illustrated, with l′ representing the position of image point P from infinity, that is, the distance from the image point P to double-liquid variable focal lens 210. As appreciated by one of ordinary skill in the art, image point P marks the location of the image plane. This distance can be expressed as follows:

$${l}^{′} = \frac{{n}_{0}}{{n}_{2}} ( \frac{{n}_{2}}{{n}_{1}} ( \frac{{n}_{1}}{{n}_{0}} ( \frac{{n}_{0}}{{n}_{2}} ( \frac{{n}_{2} {R}_{2}}{{n}_{2} - {n}_{1}} - {d}_{3} ) - {d}_{4} ) - {d}_{5} ) - {d}_{6} ) \qquad ( 2 )$$

where n₀ refers to the refractive index of air, R₂ refers to the radius of the curvature in double-liquid variable focal lens 205. As described above, the radius R₂ is determined by the voltage applied to lens 205, referred to as U₁. Voltage U₁ is related to the contact angle Θ and the radius a₁ of the cylindrical chamber in lens 205, as follows:

$${R}_{2} = - \frac{{a}_{1}}{cos θ} \qquad ( 3 )$$

That is, the focal length of optical imaging apparatus 200 depends mainly on the value of U₁ in this case. The voltage applied to double-liquid variable focal lens 210, referred to as U₂, does not affect the focal length of optical imaging apparatus 200. This is because voltage U₂ results in a planar curvature for liquid interface 245 in double-liquid variable focal lens 210. Changing the value of U₂ may result in a positive or negative curvature for liquid interface 245. As described below, an invariable image plane requires double-liquid variable focal lenses 205-210 to have opposite varying curvatures.

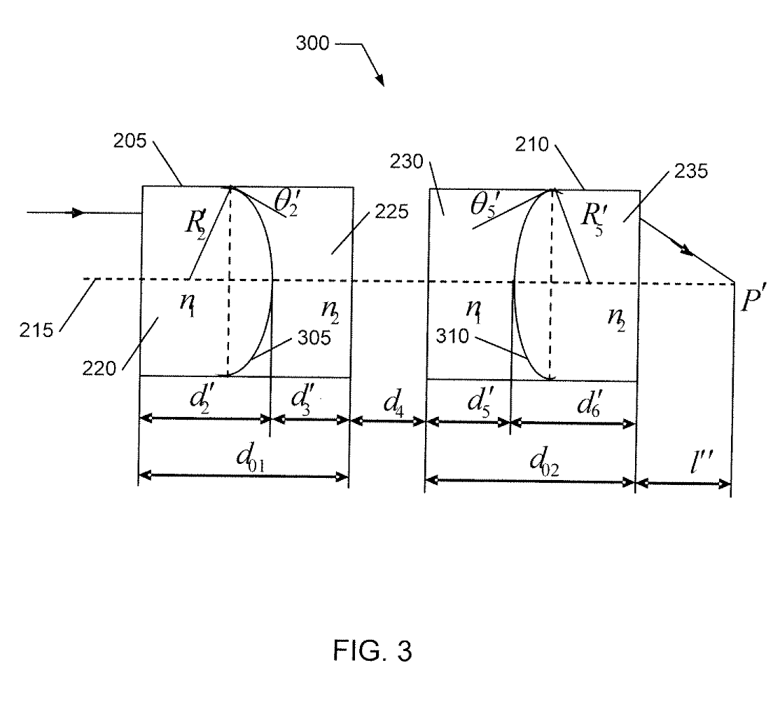

Referring now to FIG. 3, an optical imaging apparatus in which two double-liquid variable focal lenses are operable to have opposite varying curvatures and constructed in accordance with an embodiment of the invention is described. Optical imaging apparatus 300 includes double-liquid variable focal lens 205 and double-liquid variable focal lens 210 aligned on common axis 215. Double-liquid variable focal lenses 205 has a liquid interface 305 with a positive curvature resulting from a voltage U₁ applied between an electrode layer (not shown) coated inside the cylindrical chamber of lens 205 and conducting liquid 225. Similarly, double-liquid variable focal lens 210 has a liquid interface 310 with a negative curvature resulting from a voltage U₂ applied between an electrode layer (not shown) coated inside the cylindrical chamber of lens 210 and conducting liquid 235.

The opposite varying curvatures of lenses 205-210 ensure that the image plane remains invariable while the focal length of optical imaging apparatus 300 changes. This is so because when the voltage U₁ becomes larger, the power of lens 205 also becomes larger (resulting in a positive curvature for lens 205). To make the image plane invariable, the voltage U₂ must be smaller, that is, lens 210 must have a negative curvature. Conversely, if the voltage U₁ becomes smaller (resulting in a negative curvature for lens 205), the voltage U₂ must be larger (resulting in a positive curvature for lens 210). That is, the voltages applied to lenses 205-210 are applied to have one lens change its curvature in one direction and the other lens change its curvature in the opposite direction. The effect of the applicable voltages on the curvature of the lenses can be described as follows.

With various optical distances between double-liquid variable focal lenses 205-210 as illustrated, the distance l″ between image point P′ (marking the location of the image plane) and double-liquid variable focal lens 210 can be expressed as:

$$\begin{matrix}{l}^{′′} = \frac{{n}_{0}}{{n}_{2}} ( \frac{{n}_{2} {R}_{5}^{′} ( \frac{{n}_{1}}{{n}_{0}} ( \frac{{n}_{0}}{{n}_{2}} ( \frac{{n}_{2} {R}_{2}^{′}}{{n}_{2} - {n}_{1}} - {d}_{3}^{′} ) - {d}_{4} ) - {d}_{5}^{′} )}{\begin{matrix}{n}_{1} {R}_{5}^{′} + ( {n}_{2} - {n}_{1} ) \\ ( \frac{{n}_{1}}{{n}_{0}} ( \frac{{n}_{0}}{{n}_{2}} ( \frac{{n}_{2} {R}_{2}^{′}}{{n}_{2} - {n}_{1}} - {d}_{3}^{′} ) - {d}_{4} ) - {d}_{5}^{′} )\end{matrix}} - ( {d}_{02} - {d}_{5}^{′} ) ) & ( 4 ) \\ Now let β = \frac{{n}_{0}}{{n}_{2}} ( \frac{{n}_{2} {R}_{2}^{′}}{{n}_{2} - {n}_{1}} - {d}_{3}^{′} ) - {d}_{4} \\ Then & ( 5 ) \\ {l}^{′′} = \frac{{n}_{0}}{{n}_{2}} ( \frac{{n}_{2} {R}_{5}^{′} ( \frac{{n}_{1}}{{n}_{0}} β - {d}_{5}^{′} )}{{n}_{1} {R}_{5}^{′} + ( {n}_{2} - {n}_{1} ) ( \frac{{n}_{1}}{{n}_{0}} β - {d}_{5}^{′} )} - ( {d}_{02} - {d}_{5}^{′} ) ) & ( 6 )\end{matrix}$$

To make the image plane invariable, i.e., to make image point P″ and distance l″ fixed, let:

l″=l′ (7)

This results in:

$${R}_{5}^{′} = \frac{( {l}^{′} + \frac{{n}_{0}}{{n}_{2}} ( {d}_{02} - {d}_{5}^{′} ) ) ( \frac{{n}_{1}}{{n}_{0}} β - {d}_{5}^{′} ) ( {n}_{2} - {n}_{1} )}{{n}_{0} ( \frac{{n}_{1}}{{n}_{0}} β - {d}_{5}^{′} ) - {n}_{1} ( {l}^{′} + \frac{{n}_{0}}{{n}_{2}} ( {d}_{02} - {d}_{5}^{′} ) )} \qquad ( 8 )$$

Applying geometric relations between the various optical distances illustrated results in:

d′₂=k₁d₀₁+(2R′₂³+2R′₂²(R′₂²−a₁²)^{1/2}−3a₁²R′₂−2a₁²(R′₂²−a₁²)^{1/2})/(3a₁²), R′₂<0 (9)

d′₅=k₂d₀₂+(2R′₅³−2R′₅²(R′₅²−a₂²)^{1/2}−3a₂²R′₅+2a₂²(R′₅²−a₂²)^{1/2})/(3a₂²), R′₅>0 (10)

where a₁ and a₂ are the radius of lenses 205-210, respectively, and k₁ and k₂ are the volume percentages of insulating liquids 220-230 relative to the total liquid in lenses 205-210, respectively.

As described above, the voltages U₁ and U₂ applied to lenses 205-210, respectively, are related to the radii of liquid interfaces 305-310 in lenses 205-210 as follows:

R′₂=−a₁/(cos θ₀+ε₀εᵣU₁²/(2γ₁₂d)) (11)

R′₅=−a₂/(cos θ₀+ε₀εᵣU₂²/(2γ₁₂d)) (12)

where θ₀ is the initial contact angle when the applied voltages are zero, γ₁₂ is the interfacial tension between the conducting and insulating liquids in each lens, and d is the thickness of the dielectric layer (not shown) coated inside the cylindrical chamber of lenses 205-210.

On the basis of Gaussian optical theory, the focal length of optical imaging apparatus can, therefore, be expressed as:

$$f = \frac{{n}_{0} {n}_{1} {R}_{2}^{′} {R}_{5}^{′}}{( {n}_{2} - {n}_{1} ) ( \begin{matrix}{n}_{1} {R}_{5}^{′} + ( {n}_{2} - {n}_{1} ) \\ ( \frac{{n}_{1}}{{n}_{0}} ( \frac{{n}_{0}}{{n}_{2}} ( \frac{{n}_{2} {R}_{2}^{′}}{{n}_{2} - {n}_{1}} - {d}_{3}^{′} ) - {d}_{4}^{′} ) - {d}_{5}^{′} )\end{matrix} )} \qquad ( 13 )$$

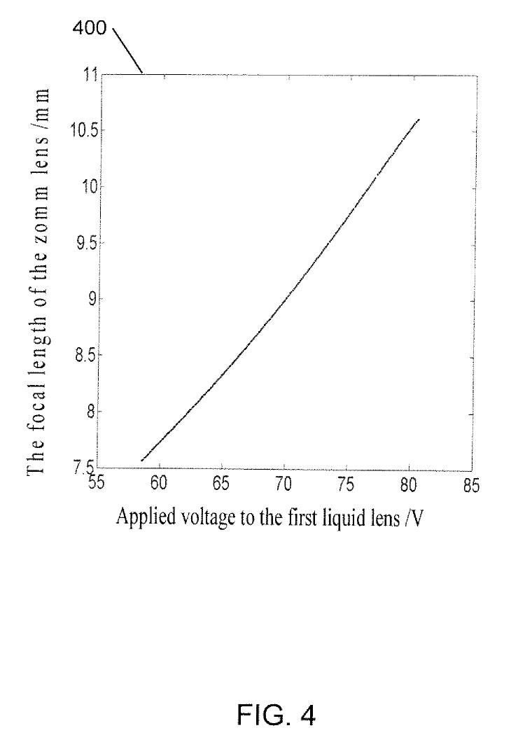

The relationship between the voltage U₁ applied to lens 205 and the focal length f of optical imaging apparatus 300 is illustrated in FIG. 4. Graph 400 shows an almost linear relationship between the applied voltage U₁ to lens 205 and the focal length f of optical imaging apparatus 300. That is, the focal length f can be varied by simply changing the applied voltages U₁ and U₂, while the image plane (represented by the image point P′ and the distance l″ in Equation (5) above) is kept invariable.

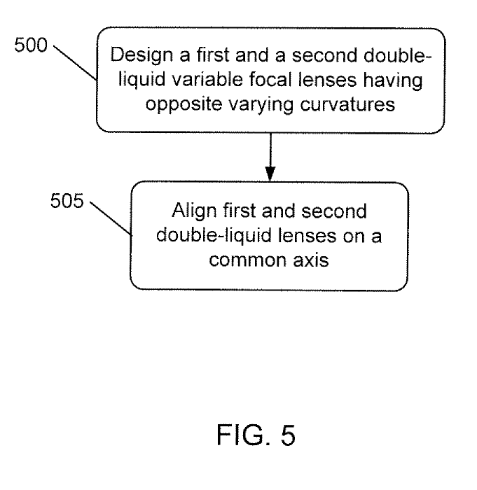

Referring now to FIG. 5, a flow chart for providing a plurality of focal lengths without mechanical movements in accordance with an embodiment of the invention is described. A first and a second double-liquid variable focal lenses are designed to be operable with opposite varying curvatures (500). The first and second double-liquid variable focal lenses may be, for example, lenses 205-210 described above.

In one embodiment, the first double-liquid variable focal lens may be designed to be a concave lens and the second double-liquid variable focal lens may be designed to be a convex lens. Alternatively, in another embodiment, the first double-liquid variable focal lens may be designed to be a convex lens and the second double-liquid variable focal lens may be designed to be a concave lens.

The first and second double-liquid variable lenses are then aligned on a common axis (505). Voltages may be applied to the first and/or second double-liquid variable lenses as described above with reference to FIGS. 2-3, in order to change the curvature of the lenses and provide a plurality of variable focal lengths. By varying the lenses' curvatures in opposite directions and by using conducting and insulating liquids that have substantially the same density but different refractive indices, the image plane of the optical imaging apparatus remains fixed while the focal length changes.

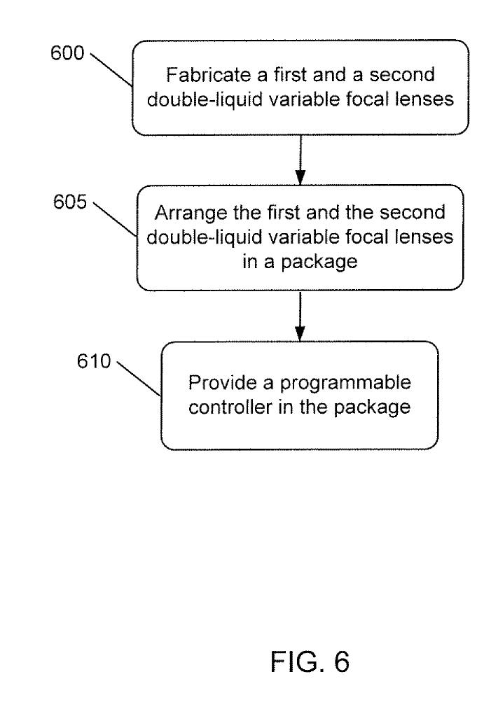

Referring now to FIG. 6, a flow chart for fabricating an optical imaging apparatus having a variable focal length in accordance with an embodiment of the invention is described. First, a first and a second double-liquid variable focal lenses are fabricated (600). The first and the second double-liquid variable focal lenses may be designed as described above with references to lenses 205-210.

Next, the first and the second double-liquid variable focal lenses are arranged in a package and aligned on a common axis (605). Lastly, a programmable controller is provided in the package to supply voltages to the first and second double-liquid variable focal lenses (610). The voltages are used to change the curvature of the liquid interfaces in the double-liquid variable focal lenses, thereby changing the focal length of the optical imaging apparatus while keeping the image plane invariable.

In one embodiment, the controller may be programmable by a user. For example, the optical imaging apparatus may be a lens assembly in a camera device having a focus control input accessible by the user to change the focal length of the lens as desired. In this case, the programmable controller receives the input from the user and applies the appropriate voltages to the first and second double-liquid variable focal lenses in order to achieve the desired focal length.

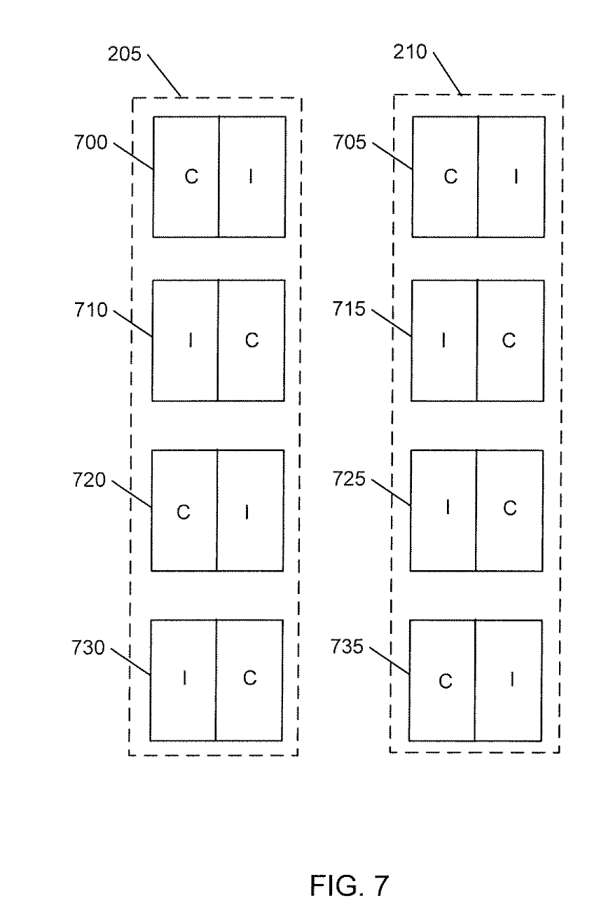

Referring now to FIG. 7, multiple configurations for the double-liquid variable focal lenses used in the optical imaging apparatuses of FIGS. 2-3 in accordance with an embodiment of the invention are described. Double-liquid variable focal lenses 205-210 each have a conducting and an insulating liquid. As described above, lenses 205-210 may have the same or a different conducting and insulating liquid. For example, lenses 205-210 may have the same conducting liquid and the same insulating liquid. The conducting liquid may be, for example, salted water with a refractive index of n₁=1.38, and the insulating liquid may be, for example, an oil liquid with a refractive index of n₂=1.55.

According to an embodiment of the invention, lenses 205-210 may have their conducting and insulating liquids placed in multiple configurations. For example, lens 205 in configuration 700 may have its insulating liquid facing the conducting liquid in lens 210 in configuration 705, lens 205 in configuration 710 may have its conducting liquid facing the insulating liquid in lens 210 in configuration 715, lens 205 in configuration 720 may have its insulating liquid facing the insulating liquid in lens 210 in configuration 725, and lens 205 in configuration 730 may have its conducting liquid facing the conducting liquid in lens 210 in configuration 735. It is appreciated that configurations 700-705, 710-715, 720-725, and 730-735 are along a common axis, passing through the center of lenses 205-210.

It is appreciated that configurations 720-725 and 730-735 are characterized by having the same type of liquid in lenses 205-210 facing each other. Accordingly, in one embodiment of the invention, a single, triple-layer double-liquid lens may be used to provide a variable focal length and an invariable image plane. The single, triple-layer, double-liquid lens is also formed of a cylindrical chamber and contains two liquids, one insulating and one conducting. However, in this embodiment, the two liquids are placed in three layers in a single, triple-layer, double-liquid lens, with one layer containing one type of liquid placed in between two layers containing the other type.

For example, the single, triple-layer, double-liquid lens could have an insulating liquid layer in between two conducting layers. Conversely, the single, triple-layer, double-liquid lens could have a conducting liquid layer in between two insulating layers. The first case would be similar to merging configurations 720-725 in a single lens, while the latter would be similar to merging configurations 730-735 in a single lens.

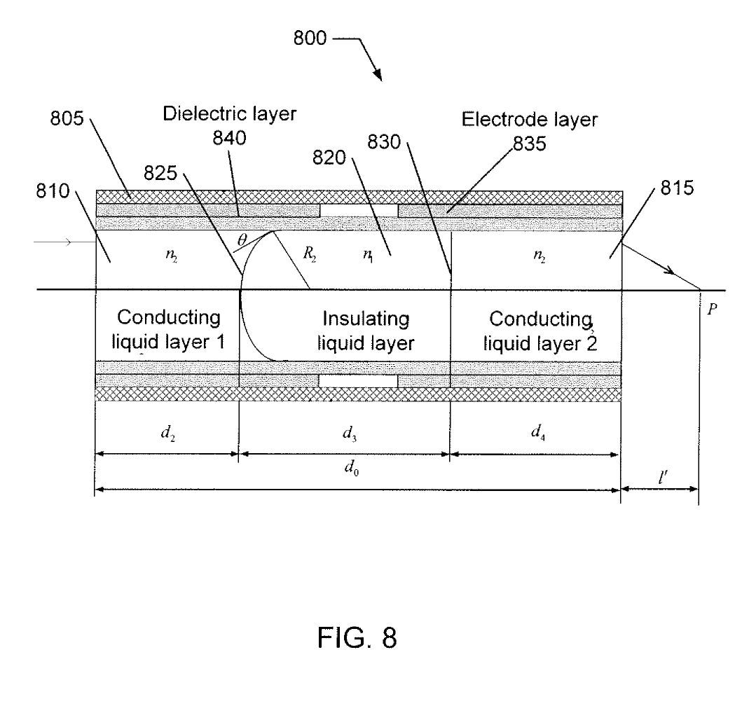

Referring now to FIG. 8, an optical imaging apparatus having a single, triple-layer, double-liquid variable focal lens constructed in accordance with an embodiment of the invention is described. Optical imaging apparatus 800 has a single, triple-layer double-liquid variable focal lens 805 formed of a cylindrical chamber enclosing three liquid layers, with one liquid layer in between two liquid layers holding the same liquid. For example, triple-layer double-liquid variable focal lens 805 has an insulating liquid layer 820 in between two conducting liquid layers 810-815.

Insulating liquid layer 820 is formed of an insulating liquid of refractive index n₁, and conducting liquid layers 810-815 are formed of a conducting liquid of refractive index n₂, with n₁>n₂. Similar to double-liquid variable focal lenses 205-210 described above with reference to FIGS. 2-3, lens 805 also has an electrode layer 835 and an dielectric layer 840 coated inside the cylindrical chamber. And similar to double-liquid variable focal lenses 205-210, lens 805 also provides a variable focal length while keeping the image plane invariable.

The three liquid layers form two liquid interfaces 825-830. Liquid interface 825 is shown with a positive curvature while liquid interface 830 is shown with a planar curvature. Similar to double-liquid variable focal lenses 205-210 described above with reference to FIGS. 2-3, the curvatures of liquid interfaces 825-830 can be controlled by changing the voltages applied between electrode layer 835 and conducting liquid layers 810-815. As described below, an invariable image plane requires that liquid interfaces 825-830 have opposite varying curvatures.

With various optical distances as illustrated, the distance l′ between image point P (marking the location of the image plane) and triple-layer, double-liquid variable focal lens 805 can be expressed as:

$${l}^{′} = \frac{{n}_{0}}{{n}_{2}} ( \frac{{n}_{2}}{{n}_{1}} ( \frac{{n}_{2} {R}_{2}}{{n}_{2} - {n}_{1}} - {d}_{3} ) - {d}_{4} ) \qquad ( 14 )$$

where the radius R₂ of liquid interface 825 is determined by the voltage U₁ applied between electrode layer 835 and conducting liquid layer 810. Radius R₂ is related to the contact angle Θ and the radius a of the cylindrical chamber in lens 805 as follows:

$${R}_{2} = \frac{a}{cos θ} \qquad ( 15 )$$

That is, the focal length of optical imaging apparatus 800 depends mainly on the value of U₁ in this case. The voltage applied between electrode layer 835 and conducting liquid layer 815, referred to as U₂, does not affect the focal length of optical imaging apparatus 800. This is because voltage U₂ results in a planar curvature for liquid interface 830. Changing the value of U₂ may result in a positive or negative curvature for liquid interface 830. As described below, an invariable image plane requires liquid interfaces 825-830 to have opposite varying curvatures.

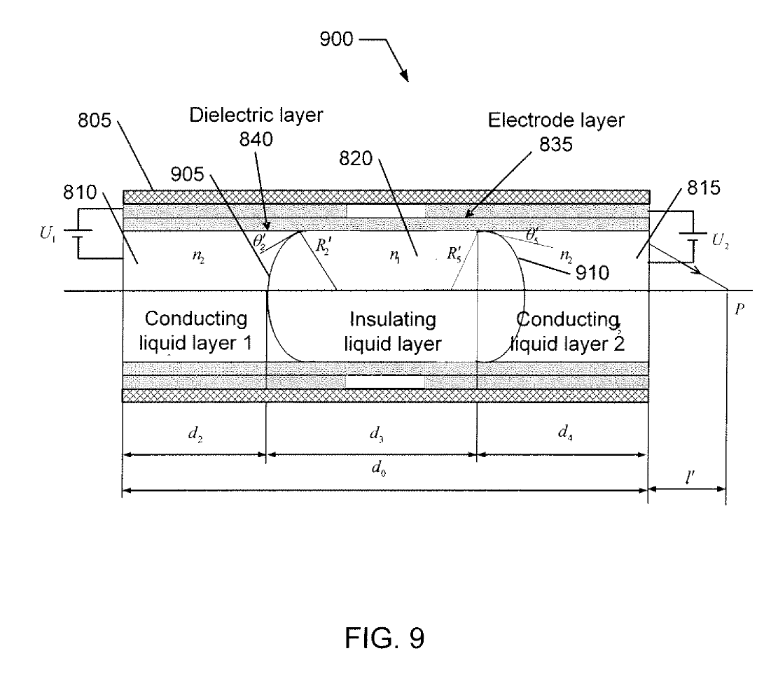

Referring now to FIG. 9, an optical imaging apparatus having a single, triple-layer, double-liquid variable focal lens constructed in accordance with an embodiment of the invention is described. Optical imaging apparatus 900 includes triple-layer, double-liquid variable focal lens 805. Triple-layer, double-liquid variable focal lenses 805 has a liquid interface 905 with a positive curvature resulting from a voltage U₁ applied between electrode layer 835 and conducting liquid layer 810, and a liquid interface 910 with a negative curvature resulting from a voltage U₂ applied between electrode layer 835 and conducting liquid layer 815.

The opposite varying curvatures of interfaces 905-910 ensure that the image plane remains invariable while the focal length of optical imaging apparatus 900 changes. This is so because when the voltage U₁ makes the radius of the first liquid interface 905 smaller, the voltage U₂ must make the radius of the second liquid interface 910 larger to keep the image point (and the image plane) fixed. The effect of the applicable voltages on the curvatures of liquid interfaces 825-830 can be described as follows.

With various optical distances as illustrated, the distance l″ between image point P′ (marking the location of the image plane) and triple-layer, double-liquid variable focal lens 805 can be expressed as:

$$\begin{matrix}{l}^{′′} = \frac{{n}_{0}}{{n}_{2}} ( \frac{{n}_{2} {R}_{5}^{′} ( \frac{{n}_{1} {R}_{2}^{′}}{{n}_{1} - {n}_{2}} - {d}_{3}^{′} )}{{n}_{1} {R}_{5}^{′} + ( {n}_{2} - {n}_{1} ) ( \frac{{n}_{1} {R}_{2}^{′}}{{n}_{1} - {n}_{2}} - {d}_{3}^{′} )} - {d}_{4}^{′} ) \\ Now let \text{:} & ( 16 ) \\ β = \frac{{n}_{1} {R}_{2}^{′}}{{n}_{1} - {n}_{2}} - {d}_{3}^{′} & ( 17 ) \\ {l}^{′′} = \frac{{n}_{0}}{{n}_{2}} ( \frac{{n}_{2} {R}_{5}^{′} β}{{n}_{1} {R}_{5}^{′} + ( {n}_{2} - {n}_{1} ) β} - {d}_{4}^{′} ) ; & ( 18 )\end{matrix}$$

To make the image plane invariable, i.e., to make image point P″ and distance l″ fixed, let:

l″=l′ (19)

This results in:

$${R}_{5}^{′} = \frac{( {l}^{′} + \frac{{n}_{0}}{{n}_{2}} {d}_{4}^{′} ) β ( {n}_{2} - {n}_{1} )}{{n}_{0} β - {n}_{1} ( {l}^{′} + \frac{{n}_{0}}{{n}_{2}} {d}_{4}^{′} )} \qquad ( 20 )$$

Applying geometric relations between the various optical distances illustrated results in:

d′₂=d₀/3+(2R′₂³+2R′₂²(R′₂²−a²)^{1/2}−3a²R′₂−2a²(R′₂²−a²)^{1/2})/(3a²), R′₂<0 (21)

d′₂=d₀/3+(2R′₂³−2R′₂²(R′₂²−a²)^{1/2}−3a²R′₂+2a²(R′₂²−a²)^{1/2})/(3a²), R′₂>0 (22)

d′₅=d₀/3+(−2R′₅³−2R′₅²(R′₅²−a²)^{1/2}+3a²R′₅+2a²(R′₅²−a²)^{1/2})/(3a²), R′₅<0 (22)

d′₅=d₀/3+(−2R′₅³+2R′₅²(R′₅²−a²)^{1/2}+3a²R′₅−2a²(R′₅²−a²)^{1/2})/(3a²), R′₅>0 (22)

where a is the radius of the cylindrical chamber in lens 825 and each liquid layer covers ⅓ of the total liquid volume in the chamber.

The voltages U₁ and U₂ are related to the radii of liquid interfaces 905-910 in lens 85 as follows:

R′₂=−a/(cos θ₀+ε₀εᵣU₁²/(2γ₁₂d)) (25)

R′₅=−a/(cos θ₀+ε₀εᵣU₂²/(2γ₁₂d)) (26)

where Θ₀ is the initial contact angle when the applied voltages are zero, γ₁₂ is the interfacial tension between the conducting and insulating liquids, and d is the thickness of dielectric layer 840.

On the basis of Gaussian optical theory, the focal length of optical imaging apparatus 900 can, therefore be expressed as:

$$f = \frac{{n}_{0} {n}_{1} {R}_{2}^{′} {R}_{5}^{′}}{( {n}_{1} - {n}_{2} ) ( {n}_{1} {R}_{5}^{′} + ( {n}_{2} - {n}_{1} ) ( \frac{{n}_{1} {R}_{2}^{′}}{{n}_{1} - {n}_{2}} - {d}_{3}^{′} ) )} \qquad ( 27 )$$

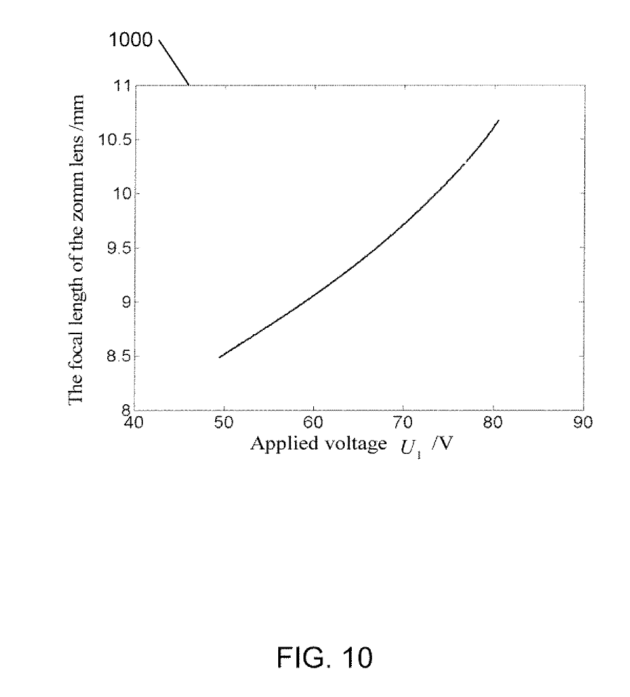

The relationship between the voltage U₁ and the focal length f of optical imaging apparatus 900 is illustrated in FIG. 10. Graph 1000 shows an almost linear relationship between the applied voltage U₁ and the focal length f of optical imaging apparatus 900. That is, the focal length f can be varied by simply changing the applied voltages U₁ and U₂, while the image plane (represented by the image point P′ and the distance l″ in Equation (17) above) is kept invariable.

It is appreciated by one of ordinary skill in the art that lens 805 is shown with two conducting layers 810-815 and one insulating layer 820 for illustration purposes only. A lens having two insulating layers and one conducting layer may also be used to provide a variable focal length and an invariable image plane.

According to another embodiment of the invention, an optional fixed lens may be combined with the double-liquid lenses described above (i.e., lens 205-210 and lens 805). The fixed lens may be used to improve the optical properties of the optical imaging apparatus while keeping the image plane invariable for a variable focal length. Those optical properties may include, for example, dispersion, zoom capabilities, and chromatic aberration, among others.

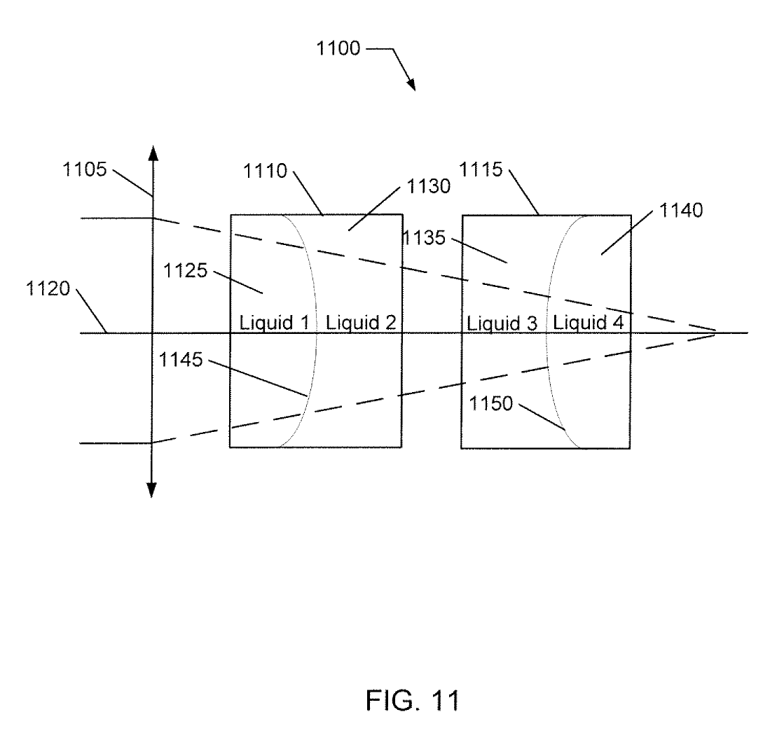

Referring now to FIG. 11, an optical imaging apparatus constructed in accordance with an embodiment of the invention is described. Optical imaging apparatus 1100 includes fixed lens 1105, double-liquid variable focal lens 1110, and double-liquid variable focal lens 1115. In this embodiment, double-liquid variable focal lenses 1110-1115 are placed between the exit pupil and the back focus plane of fixed lens 1105. Fixed lens 1105 and double-liquid variable focal lenses 1110-1115 are all aligned on a common axis 1120, passing through the center of lenses 1105-1115.

Double-liquid variable focal lenses 1110-1115 may be any double-liquid variable focal lens known to one of ordinary skill in the art, such as, for example, double-liquid variable focal lens 205-210 shown in FIGS. 2-3. According to an embodiment of the invention, lenses 1110-1115 are designed to have opposite varying curvatures. For example, lens 1110 may be a concave (i.e., negative) lens and lens 1115 may be a convex (i.e., positive) lens as shown. Alternatively, lens 1110 may be a convex lens and lens 1115 may be a concave lens. As described in more detail herein below, the opposite varying curvatures of the lenses enables the focal or image plane of optical imaging apparatus 1100 to remain invariable for a variable focal length.

It is appreciated by one of ordinary skill in the art that the focal power of optical imaging apparatus 1100 is mainly determined by fixed lens 1105. It is also appreciated that the curvature of lenses 1110-1115 may be modified as desired by the voltages applied to lenses 1110-1115 (while still keeping the curvatures to have opposite signs). That is, the voltages applied to lenses 1110-1115 are applied to have one lens change its curvature in one direction and the other lens change its curvature in the opposite direction. For example, when lens 1110 acts as a concave lens and lens 1115 acts as a convex lens under applied voltages, lens 1110 diverges incoming light rays and lens 1115 converges the rays. That is, the convergence angle on the image plane of fixed lens 1105 increases and the combined focal length of optical imaging apparatus 1100 decreases if the image plane remains fixed. Conversely, the combined focal length of optical imaging apparatus 1100 increases when lens 1110 acts as a convex lens and lens 1115 acts as a concave lens under applied voltages.

It is further appreciated that the focal length of optical imaging apparatus 1100 can be readily adjusted by changing the applied voltages without any mechanical movements. In addition, a proper regulation of the applied voltages can also ensure that the summation of conjugate distances of lenses 1105-1115 remains fixed, farther contributing to an invariable image plane.

An invariable image plane results in better focus of the image in the image acquisition surface, such as a camera film or image sensor, thereby leading to improved image quality. The lack of mechanical movements to achieve a variable focal length while keeping the image plane invariable makes the optical imaging apparatus of the invention especially suitable for use in small cameras (such as those in mobile devices) or any other device where robustness, size, speed, power consumption, and ease of use are of crucial importance.

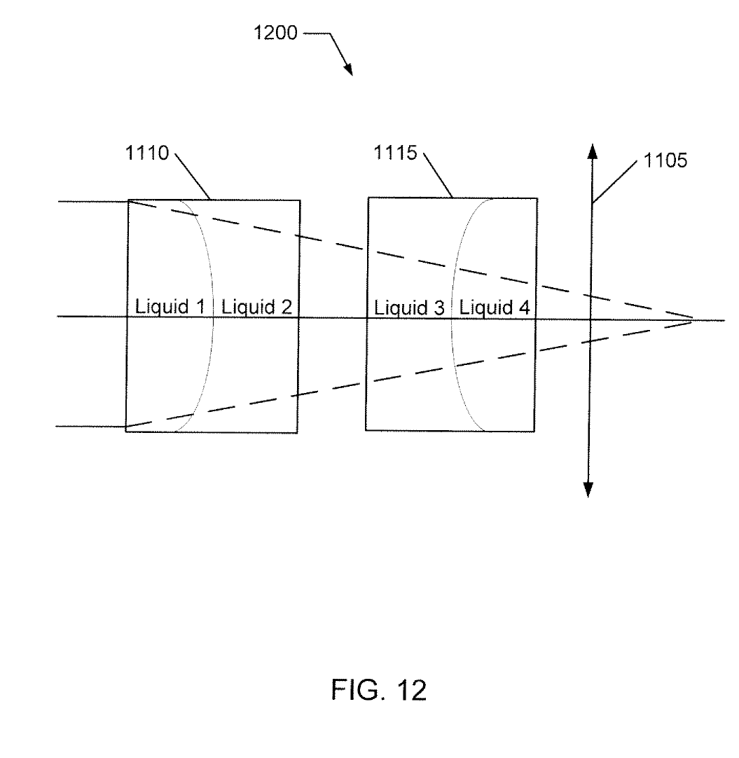

FIG. 12 illustrates an optical imaging apparatus constructed in accordance with another embodiment of the invention. Optical imaging apparatus 1200 has double-liquid variable focal lens 1110, double-liquid variable focal lens 1115, and fixed lens 1105 arranged in a different configuration. In this embodiment, double-liquid variable focal lenses 1110-1115 are placed before fixed lens 1105. It is appreciated that the image plane of optical imaging apparatus 1200 is kept invariable, while its image plane changes.

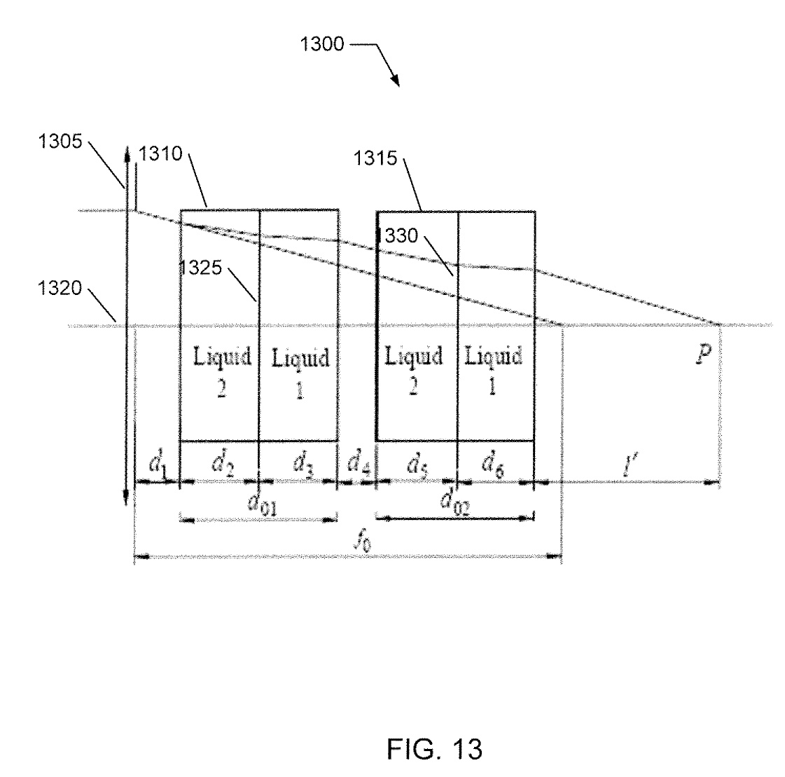

Referring now to FIG. 13, a schematic diagram of an optical imaging apparatus when both double-liquid variable focal lenses operate with planar liquid interfaces in accordance with an embodiment of the invention is described. Optical imaging apparatus 1300 includes fixed lens 1305, double-liquid variable focal lens 1310 and double-liquid variable focal lens 1315, aligned along common axis 1320, passing through the center of lenses 1305-1315.

In the embodiment shown, double-liquid variable focal lenses 1310-1315 have a liquid 1 and a liquid 2. Liquid 1 may be a conducting or insulating liquid. Conversely, liquid 2 may be an insulating (when liquid 1 is a conducting liquid) or conducting (when liquid 1 is an insulating liquid) liquid. For illustration and description purposes, liquid interface 1325 in double-liquid variable focal lens 1310 and liquid interface 1330 in double-liquid variable focal lens 1315 are a plane under applicable voltages.

In this case, when liquid interfaces 1325-1330 become a plane under applicable voltages, double-liquid variable focal lenses 1310-1315 can be treated as a plane-parallel plate, which has no contribution to the total focal power of optical imaging apparatus 1300. That is, two double-liquid variable focal lenses can only change the focus position of the optical imaging apparatus 1300, i.e., they can only change the focal length of the optical imaging apparatus 1300. The focal power of the optical imaging apparatus 1300 is determined by fixed lens 1305.

The focus position of the optical imaging apparatus, defined by l′, i.e., the distance from the focus point P to the back surface of the second double-liquid variable focal lens 1315, can be expressed as:

l′=(f₀−d₁)−n₀d₂/n₁−n₀d₃/n₂−d₄−n₀d₅/n₁−n₀d₅/n₂ (28)

where n₀ is the refractive index of air, n₁ is the refractive index of liquid 1 as illustrated, n₂ is the refractive index of liquid 2 as illustrated, f₀ is the focal length of fixed lens 1305, and d₁, d₂, d₃, d₄, d₅, and d₆ are distances as illustrated.

For a optical imaging apparatus 1300, l′ is a constant, that is, the image plane is fixed. Now let the thickness of the first and second double-liquid variable focal lenses 1310-1315 be expressed by d₀₁ and d₀₂, respectively, the volume percentage of liquid 2 in lens 1310 be expressed by k₁ and the volume percentage of liquid 2 in lens 1315 be expressed by k₂. That is, d₂=k₁d₀₁ and d₅=k₂d₀₂. Equation (28) above may then be rewritten as:

l′=(f₀−d₁−d4)−n₀(k₁d₀₁+k₂d₀₂)(n₂−n₁)/(n₁n₂)=n₀(d₀₁+d₀₂)/n₂ (29)

In the general case, liquid interfaces 1325-1330 may be either convex or concave. To keep the focus position of the optical imaging apparatus 1300 invariable, one of the liquid interfaces 1325-1330 is a convex interface while the other is a concave interface. That is, the curvatures of interfaces 1325-1330, i.e., the curvature of lenses 1310-1315, are opposite curvatures.

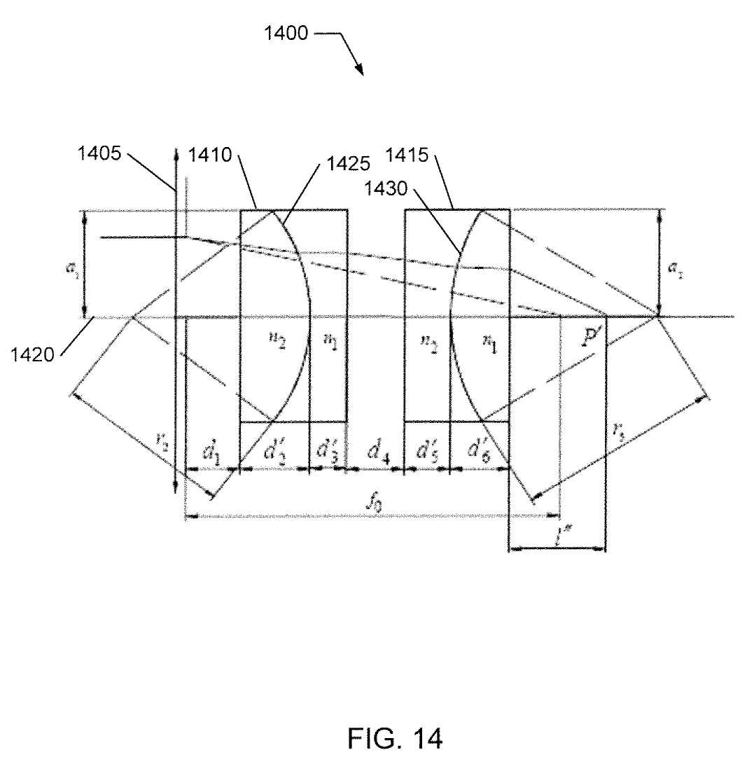

Referring now to FIG. 14, a schematic diagram of an optical imaging apparatus with non-zero focal power for both double-liquid variable focal lenses in accordance with an embodiment of the invention is described. Optical imaging apparatus 1400 has fixed lens 1405, double-liquid variable focal lens 1410 and double-liquid variable focal lens 1415, all aligned along common axis 1420, passing through the center of lenses 1405-1415.

In this embodiment, double-liquid variable focal lens 1410 has a concave interface (i.e., negative radii r₂) while double-liquid variable focal lens 1415 has a convex interface (i.e., positive radii r₅). The focus position l″ of optical imaging apparatus 1400 in this case can be expressed as:

$$\begin{matrix}{l}^{′} = \frac{{n}_{0}}{{n}_{2}} \cdot [ \frac{{n}_{2} ( {n}_{1} α / {n}_{0} - {d}_{5}^{′} ) {r}_{5}}{{n}_{1} {r}_{5} + ( {n}_{1} α / {n}_{0} - {d}_{5}^{′} ) ( {n}_{2} - {n}_{1} )} - ( {d}_{02} - {d}_{5}^{′} ) ] \\ where & ( 30 ) \\ α = \frac{{n}_{0}}{{n}_{2}} \{ \begin{matrix}\frac{{n}_{2} {r}_{2} [ {n}_{1} ( {f}_{0} - {d}_{1} ) / {n}_{0} - {d}_{2}^{′} ]}{{n}_{1} {r}_{2} + [ {n}_{1} ( {f}_{0} - {d}_{1} ) / {n}_{0} - {d}_{2}^{′} ] ( {n}_{2} - {n}_{1} )} - \\ ( {d}_{01} - {d}_{2}^{′} )\end{matrix} \} - {d}_{4} & ( 31 )\end{matrix}$$

Since r₂ (or r₅) and d′₂ (or d′₅) are geometrically related, the latter can be expressed as a function of the former, that is:

d′₂=k₁d₀₁[2r₂³+2r₂²(r₂²−a₁²)^{1/2}−3a₁²r₂−2a₁²(r₂²−a₁²)^{1/2}]/(3a₁²), r₂<0 (32)

d′₅=k₂d₀₂[2r₅³−2r₅²(r₅²−a₂²)^{1/2}−3a₂²r₅+2a₂²(r₅²−a₂²)^{1/2}]/(3a₂²), r₅>0 (33)

where a₁ and a₂ are the inner radius of the cylindrical chambers in double-liquid variable focal lenses 1410-1415, respectively.

Equations (32) and (33) above also show that the absolute value for both r₂ and r₅ have a lower limit, that is, |r₂|≧a₁ and |r₅|≧a₂. To keep the focus position, i.e., the image plane of optical imaging apparatus 800 fixed, the following holds:

l″=l′ (34)

Substituting Equation (30) into Equation (34), results in:

$${r}_{5} = \frac{( {n}_{2} {l}^{′} + {d}_{02} - {d}_{5}^{′} ) ( {n}_{1} α - {d}_{5}^{′} ) ( {n}_{2} - {n}_{1} )}{{n}_{2} ( {n}_{1} α - {d}_{5}^{′} ) - {n}_{1} ( {n}_{2} {l}^{′} + {d}_{02} - {d}_{5}^{′} )} \qquad ( 35 )$$

where α is a unction of r₂ and r₅ is implicated in d′₅. When r₂, which is determined by the voltage applied to lens 1410, is given, Equation (35) can be solved analytically. However, this results in a higher-order equation in terms of r₅ having extraneous roots. The relation between r₅ and r₂ can be achieved by a numerically iterative method.

Let the voltages applied to lenses 1410-1415 be U₁ and U₂, respectively. According to Equation (1), the following holds:

r₂=−a₁/[cos θ₀+ε₀εᵣU₁²/(2γ₁₂d)] (36)

r₅=−a₂/[cos θ₀+ε₀εᵣU₂²/(2γ₁₂d)] (37)

Since there exits a one-to-one correspondence between the applied voltages U₁ and U₂ and the liquid interface radii r₂ and r₅, the relationship between r₂ and r₅ can be readily expressed into that of U₁ and U₂. Under such circumstances, the combined focal length of optical imaging apparatus 800, denoted by f, can be expressed in r₂ and r₅ as:

$$f = \frac{{n}_{1}^{2} {r}_{2} {r}_{5} {f}_{0}}{\begin{matrix}\{ \begin{matrix}{n}_{1} {r}_{2} + [ {n}_{1} ( {f}_{0} - {d}_{1} ) / {n}_{0} - {d}_{2}^{′} ] \\ ( {n}_{2} - {n}_{1} )\end{matrix} \} \\ [ {n}_{2} - {n}_{1} ) ( {n}_{1} α / {n}_{0} - {d}_{5}^{′} ) + {n}_{1} {r}_{5} ]\end{matrix}} - \qquad ( 38 )$$

It is appreciated that Equation (38) above indicates that the focal length of optical imaging apparatus 1400 varies only with the radii r₂ and r₅ of lenses 1410-1415, which, in turn, vary with the applied voltages U₁ and U₂, respectively. That is, changing the voltage applied to lenses 1410-1415 results in a variable focal length for the entire optical imaging apparatus 1400 while the image plane is kept invariable (with the lenses 1410-1415 having opposite varying curvatures).

In addition, it is appreciated that the contribution of fixed lens 1405 in Equation (38) above, i.e., the contribution of fixed lens 1405 to the focal length of optical imaging apparatus 1400 is mainly due to its focal length f₀ and to its positioning relative to double-liquid variable focal lenses 1410-1415. It is then appreciated that fixed lens 805 is arranged relative to double-liquid variable focal lenses 1410-1415 in order to achieve an extended range of focal lengths f given the practical range of applicable voltages U₁ and U₂ (typically around 0-100 V).

It is further appreciated that a similar derivation can be performed for the case where lens 1410 is a convex lens and lens 1415 is a concave lens. Optical imaging apparatus 1400 can therefore realize the function of zooming and focusing to observe a large area with small magnification or a small area with large magnification.

In order to illustrate the focal properties of the optical imaging apparatus of the invention, simulation results are described below. A set of parameters are specified as follows: n₀−1, n₁−1.38, n₂−1.55, d₀₁−d₀₂−2 mm, d₁=0.05 mm, d₄=2.95 mm, k₁=⅓, k₂=⅔, and f₀=10 mm.

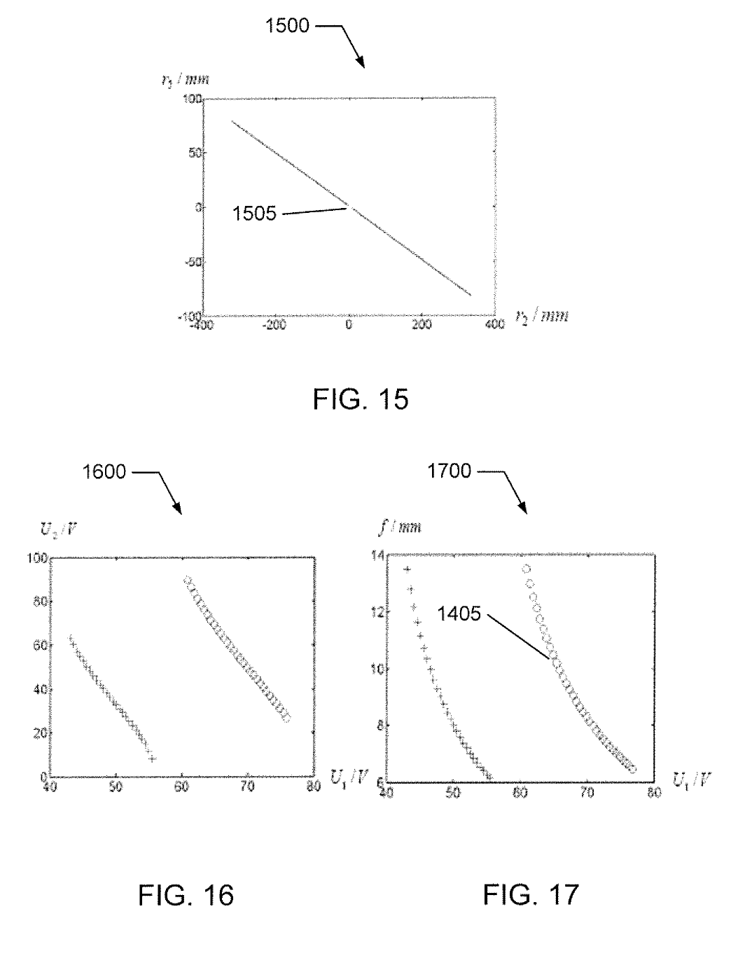

Referring now to FIG. 15, a graph showing the interface radius of the second double-liquid variable focal lens as a function of the interface radius of the first double-liquid variable focal lens in accordance with an embodiment of the invention is described. Graph 1500 shows radius r₅ of lens 1415 as a function of radius r₂ of lens 1410 according to Equation (35) above. As shown in FIG. 15, the signs of r₅ and r₂ remain opposite. Due to the limits mentioned earlier for r₂ and r₅, there exists a gap 1505 in graph 1500 corresponding to the limited range.

Additional simulation results can be obtained by specifying the inner radii (for example a₁=a₂=1 mm) and choose two liquids with a liquid interface tension coefficient of γ₁₂=38.1×10⁻³ N/m for two double-liquid variable focal lenses. Referring now to FIG. 16, a graph showing the voltage applied to the second double-liquid variable focal lens as a function of the voltage applied to the first double-liquid variable focal lens in accordance with an embodiment of the invention is described. The relationship between voltages U₂ and U₁ can be simulated for different dielectric thicknesses. Graph 1600 shows the resulting relationship between U₂ and U₁.

Referring now to FIG. 17, a graph showing the focal length of an optical imaging apparatus constructed in accordance with an embodiment of the invention as a function of the voltage applied to the first double-liquid variable focal lens is described. Graph 1700 shows the focal length of optical imaging apparatus 1400 as a function of the applied voltage U₁ for two different thicknesses of the dielectric layer.

As shown in FIG. 17, for a dielectric layer with larger thickness (curve 1705), larger voltages are required in order to obtain the same range of the focal length for optical imaging apparatus 1400. In one embodiment, the continuous optical zoom of optical imaging apparatus 1400 can reach up to 1:2 while keeping the image plane invariable.

It is appreciated that the simulation results shown in FIGS. 15-17 do not consider any aberrations. It is also appreciated that Equations (28)-(38) above are based on an infinite object and that similar derivations can be made for finite objects.

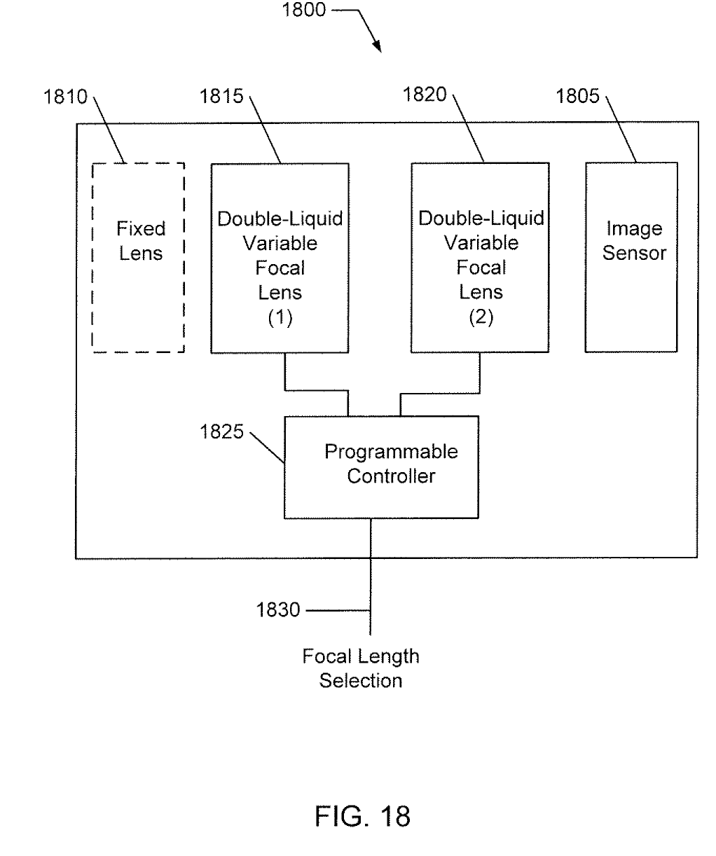

Referring now to FIG. 18, a programmable multi-focal camera constructed in accordance with an embodiment of the invention is described. Programmable multi-focal camera 1800 includes an image sensor 1805 and an optical imaging apparatus having an optional fixed lens 1810, a first and a second double-liquid variable focal lenses 1815-1820, and a programmable controller 1825. As described above, programmable controller 1825 provides voltages to lenses 1815-1820 to result in a plurality of focal lengths while keeping the image plane invariable. The focal lengths can be specified by a user as desired, via focal selection input 1830.

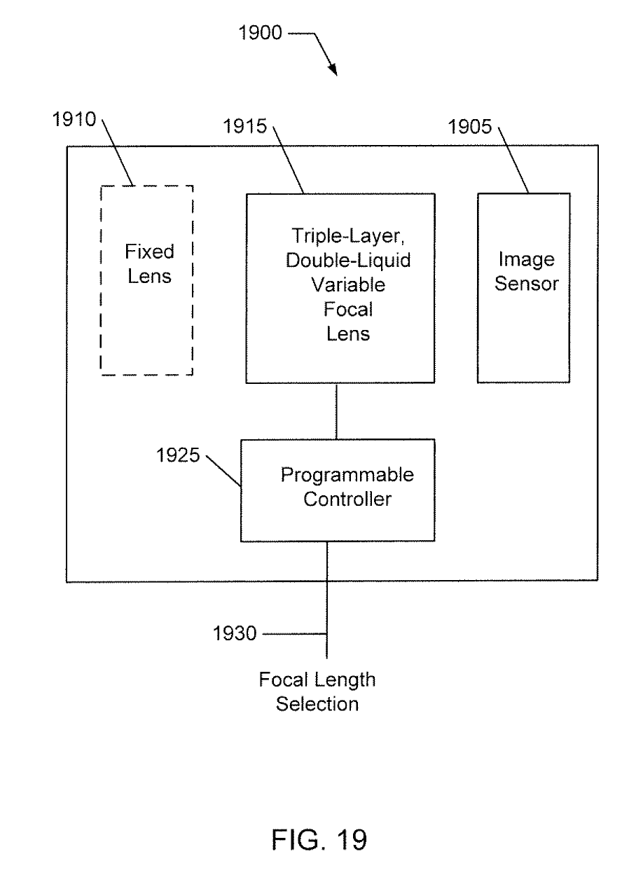

FIG. 19 illustrates a programmable multi-focal camera constructed in accordance with another embodiment of the invention. Programmable multi-focal camera 1900 includes an image sensor 1905 and an optical imaging apparatus having a triple-layer, double-liquid variable focal lens 1910, and a programmable controller 1925. As described above, programmable controller 1925 provides voltages to lens 1910 to result in a plurality of focal lengths while keeping the image plane invariable. The focal lengths can be specified by a user as desired, via focal selection input 1930.

Advantageously, the optical imaging apparatuses of the invention provide multiple focal lengths in a single, small and efficient package that can be programmed and electrically controlled to provide fast focal speed and accuracy. The package may be used in a variety of imaging devices, including, but not limited to, viewing devices such as glasses, binoculars and telescopes, scientific instruments such as microscopes and spectroscopes, analog and digital cameras, video cameras, medical devices such as optical catheter and endoscopes, and the like.

For example, an optical imaging apparatus may be integrated into a programmable camera for achieving multiple selectable focal lengths while keeping the image plane invariable. An invariable image plane results in better focus of the image in the image sensor, thereby leading to improved image quality. The lack of mechanical movements to achieve a variable focal length while keeping the image plane invariable makes the optical imaging apparatuses of the invention especially suitable for use in small cameras (such as those in mobile devices) or any other device where robustness, size, speed, power consumption, and ease of use are of crucial importance.

The programmable camera allows users to seamlessly and speedily change focal lengths while capturing images at varying distances. In contrast with traditional zoom lenses, the optical imaging apparatuses built according to embodiments of the invention are fast, provide a more accurate focus, has lower power consumption, fewer optical elements and is easily miniaturized.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

1. An optical imaging apparatus having a variable focal length, comprising:
a first double-liquid variable focal lens; and
a second double-liquid variable focal lens,
the first and second double-liquid variable focal lenses aligned on a common axis and operable to have opposite varying curvatures.

2. The optical imaging apparatus of claim 1, further comprising a fixed lens aligned with the first and second double-liquid variable focal lenses.

3. The optical imaging apparatus of claim 1, further comprising a programmable controller configured to independently address a first voltage to the first double-liquid variable focal lens and a second voltage to the second double-liquid variable focal lens to provide a plurality of focal lengths and an invariable image plane.

4. The optical imaging apparatus of claim 3, wherein the first voltage is applied to the first double-liquid variable lens to generate a first curvature.

5. The optical imaging apparatus of claim 4, wherein the second voltage is applied to the second double-liquid variable lens to generate a second curvature.

6. The optical imaging apparatus of claim 5, wherein the first curvature is a convex curvature and the second curvature is a concave curvature.

7. The optical imaging apparatus of claim 6, wherein the first curvature is a concave curvature and the second curvature is a convex curvature.

8. The optical imaging apparatus of claim 1, wherein the first double-liquid variable focal lens comprises:
a first cylindrical chamber enclosing a first liquid and a second liquid having substantially the same density and different refractive indices; and
an electrode layer and a hydrophobic dielectric layer coated inside the first cylindrical chamber.

9. The optical imaging apparatus of claim 8, wherein the second double-liquid variable focal lens comprises:
a second cylindrical chamber enclosing a third liquid and a fourth liquid having substantially the same density and different refractive indices; and
an electrode layer and a hydrophobic dielectric layer coated inside the second cylindrical chamber.

10. The optical imaging apparatus of claim 9, wherein the first liquid comprises a first conductive liquid and the second liquid comprises a first insulating liquid.

11. The optical imaging apparatus of claim 10, wherein the third liquid comprises a second conductive liquid and the second liquid comprises a second insulating liquid.

12. A method for providing a plurality of focal lengths without mechanical movements, comprising:
designing a first and a second double-liquid variable focal lenses operable to have opposite varying curvatures; and
aligning the first and second double-liquid variable focal lenses on a common axis.

13. The method of claim 12, further comprising providing a fixed lens aligned with the first and second double-liquid variable focal lenses on the common axis.

14. The method of claim 13, further comprising:
applying a first voltage to the first double-liquid variable focal lens to control a first curvature; and
applying a second voltage to the second double-liquid variable focal lens to control a second curvature, the second curvature controlled to be opposite from that of the first curvature.

15. The method of claim 14, further comprising varying the first and second voltages to provide a plurality of focal lengths.

16. A method of fabrication of an optical imaging apparatus having a variable focal length, comprising:
fabricating a first and a second double-liquid variable focal lenses;
arranging the first and the second double-liquid variable focal lenses in a package; and
providing a programmable controller in the package to apply a first voltage to the first double-liquid variable focal lens and a second voltage to the second double-liquid variable focal lens,
the first voltage controlling a first curvature on the first double-liquid variable focal lens and the second voltage controlling a second curvature on the second double-liquid variable focal lens.

17. The method of claim 16, further comprising providing a fixed lens in the package, the fixed lens aligned on a common axis with the first and second double-liquid variable focal lenses.

18. The method of claim 17, further comprising varying the first and second voltages to keep the second curvature varying oppositely from the first curvature to provide an invariable image plane.

19. A programmable multi-focal camera, comprising:
an image sensor to generate image data from an optical image; and
a programmable optical assembly to capture the optical image, the programmable optical assembly comprising:
a first and a second double-liquid variable focal lens; and
a programmable controller configured to independently address a first voltage to the first double-liquid variable focal lens and a second voltage to the second double-liquid variable focal lens to provide a plurality of focal lengths and an invariable image plane at the image sensor.

20. The programmable multi-focal camera of claim 19, wherein the programmable optical assembly further comprises a fixed lens aligned on a common axis with the first and second double-liquid variable focal lenses.

21. The programmable multi-focal camera of claim 20, wherein the programmable controller comprises an input for selecting a focal length from the plurality of focal lengths.

22. The programmable multi-focal camera of claim 21, wherein the first double-liquid variable focal lens comprises:
a first cylindrical chamber;
a first and a second liquid enclosed within the first cylindrical chamber,
the first and second liquids having substantially the same density and different refractive indices;
a first hydrophobic dielectric layer coated inside the first cylindrical chamber; and
a first electrode layer coated on the first hydrophobic dielectric layer.

23. The programmable multi-focal camera of claim 22, wherein the second double-liquid variable focal lens comprises:
a second cylindrical chamber;
a third and a fourth liquid enclosed within the second cylindrical chamber,
the third and fourth liquids having substantially the same density and different refractive indices;
a second hydrophobic dielectric layer coated inside the second cylindrical chamber; and
a second electrode layer coated inside the second hydrophobic dielectric layer.

24. The programmable multi-focal camera of claim 23, wherein the first and third liquid comprise a conductive liquid.

25. A variable focal lens, comprising:
a cylindrical chamber;
a first and a second liquid layers enclosed within the cylindrical chamber and holding a liquid of a first type; and
a third liquid layer in between the first and the second liquid layers and holding a liquid of a second type.

26. The variable focal lens of claim 25, wherein the liquid of a first type comprises a conducting liquid and the liquid of a second type comprises an insulating liquid.

27. The variable focal lens of claim 26, wherein the liquid of a first type comprises an insulating liquid and the liquid of a second type comprises a conducting liquid.

28. The variable focal lens of claim 27, wherein the first liquid layer and the third liquid layer form a first liquid interface and the second liquid layer and the third liquid layer form a second liquid interface.

29. The variable focal lens of claim 28, wherein the first and the second liquid interfaces have opposite varying curvatures.

30. The variable focal lens of claim 29, wherein the conducting liquid and the insulating liquid have substantially the same density and different refractive indices.

31. The variable focal lens of claim 25, further comprising:
a hydrophobic dielectric layer coated inside the cylindrical chamber; and
a electrode layer coated inside the hydrophobic dielectric layer.

32. A method of fabrication of an optical imaging apparatus having a variable focal length, comprising:
fabricating a triple-layer, double-liquid variable focal lens, having a first and a second liquid layers holding a liquid of a first type and a third liquid layer holding a liquid of a second type placed in between the first and the second liquid layers;
arranging the triple-layer, double-liquid variable focal lens in a package; and
providing a programmable controller in the package to apply voltages to the liquid layers.

33. The method of claim 32, wherein the liquid of a first type comprises a conducting liquid and the liquid of a second type comprises an insulating liquid.

34. The method of claim 33, wherein the liquid of a first type comprises an insulating liquid and the liquid of a second type comprises a conducting liquid.

35. The method of claim 34, wherein the first liquid layer and the third liquid layer form a first liquid interface and the second liquid layer and the third liquid layer form a second liquid interface.

36. The method of claim 35, wherein providing the programmable controller comprises applying a voltage to the first and the second liquid layers, the first and the second liquid layers holding a conducting liquid and the third liquid layer holding an insulating liquid.

37. The method of claim 35, wherein providing the programmable controller comprises applying a voltage to the third liquid layer, the third liquid layer holding a conducting liquid and the first and the second liquid layers holding an insulating liquid.
